(19) United States
(12) Patent Application Publication
(10) Pub. No.: US 2011/0120027 A1
(43) Pub. Date: May 26, 2011

(54) Safety barrier

(76) Inventor: Samuel Joseph Massameno, Torrington, CT (US)

(21) Appl. No.: 12/592,502

(22) Filed: Nov. 25, 2009

(51) Int. Cl. E06B 3/30; E06B 7/00; E04B 1/00; E04B 2/00

(52) U.S. Cl. 52/105; 49/70; 52/202; 52/474

(57) ABSTRACT

The present invention is a strong, safety barrier that can be affixed to the inside of a wood or metal-framed opening at a construction site so as to prevent passage and resulting injury while permitting installation of finished walls and flooring. In particular, the safety barrier consists of a material, in a substantially planar shape, that attaches to the lower, inside area between the rough opening of a passage way in the area of a building that is under construction and not safe for human passage, which when properly installed, will prevent human passage and resultant injury and also provide a written warning of danger, with universally recognized signage. The barrier has three flaps, one on each of the two lateral ends and on the bottom, that are to be secured to the outside of the inner edge of the rough, wood or metal-framed opening by inserting seven provided anchoring devices, which are accompanied by seven tight-fitting washers, through said flaps, at identified intervals, into said rough wood or metal-framed opening at the locations identified.

### CROSS-REFERENCE TO RELATED APPLICATIONS

None

### STATEMENT REGARDING FEDERALLY SPONSORED

### RESEARCH OR DEVELOPMENT

The invention that is the subject of this specification has not been made under federally sponsored research and development.

### REFERENCE TO SEQUENCE LISTING, TABLE, OR COMPUTER PROGRAM

This specification does not include reliance upon any information contained in a compact disc.

### BACKGROUND OF THE INVENTION

The invention that is the subject of this specification relates generally to methods and apparatuses used to block entry to a dangerous area of a building under construction. Under prior art, boards such as 2×4 wood studs or pieces of plywood, would be nailed onto wood studs that framed the entrance to a dangerous area of the building. Similar boards or pieces of plywood would be affixed with screws to metal studs that framed the entrance to such an area. These methods of preventing entry to a dangerous area were deficient for several reasons.

First, the boards or plywood that would be used would not necessarily prevent human passage through the opening because such boards, unless they blocked the entire opening, often allowed some access to the area, especially by small children. As a result, the prior art afforded inadequate protection from what could have been a substantial risk of death or serious physical injury.

Second, the boards or plywood that would be used would overlap the rough opening itself, preventing or thwarting the process of finishing the walls and floors in the area surrounding such opening.

Third, even if the boards or plywood that would be used were installed in such a way as to be fully effective at preventing human passage, they would not easily be installed or removed, requiring significant time and effort.

Fourth, the boards or plywood that would be used typically would not contain any written warning of danger or any universally recognized symbol warning of a danger from falling or entering into a hazardous area. Where the area into which the passage way led was an elevator shaft, for example, the risk of death or serious bodily injury was great, while the protection afforded in the prior art often was inadequate to assure substantial protection from such an elevated risk.

### BRIEF SUMMARY OF THE INVENTION

The present invention relates to a strong, safety barrier that can be affixed to the inside of a wood or metal-framed opening at a construction site so as to prevent passage and resulting injury while permitting installation of finished walls and flooring. In particular, the safety barrier consists of a material, in a substantially planar shape, that attaches to the lower, inside area between the rough opening of a passage way in the area of a building that is under construction and not safe for human passage, which when properly installed, will prevent human passage and resultant injury and also provide a written warning of danger, with universally recognized signage. The barrier has three flaps, one on each of the two lateral ends and on the bottom, that are to be secured to the outside of the inner edge of the rough, wood or metal-framed opening by inserting seven provided anchoring devices, which are accompanied by seven tight-fitting washers, through said flaps, at identified intervals, into said rough wood or metal-framed opening at the locations identified.

### BRIEF DESCRIPTION OF THE DRAWING

FIG. 1 depicts the side of the safety barrier not exposed to hazard 1 and the three flaps of the barrier that are to used to secure it. The side flaps are identified by the number 2. The bottom flap is identified by the number 3. The lateral and bottom indentations are identified by the number 4. The anchoring devices are identified by the number 5.

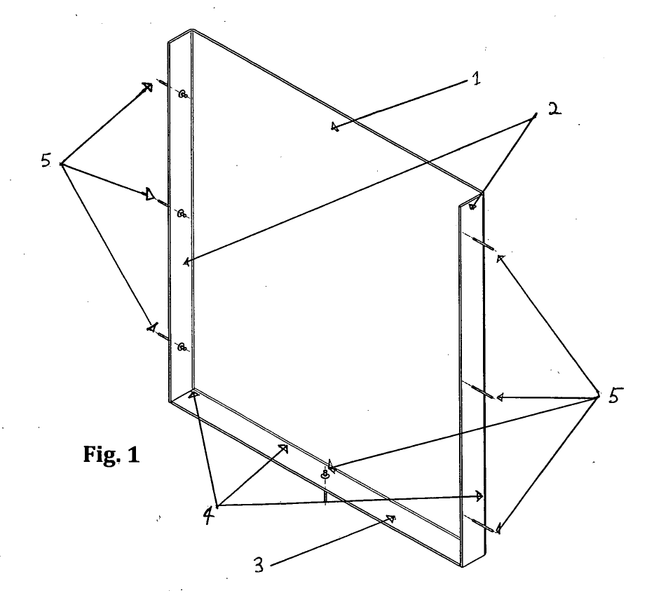

FIG. 2 depicts the side of the safety barrier not exposed to hazard 1a, and the lateral and bottom indentations 2a that form the borders of the lateral flaps 3a and of the bottom flap 4a. The boxes containing installation instructions and signage, together with universal symbols of danger, are identified as 5a.

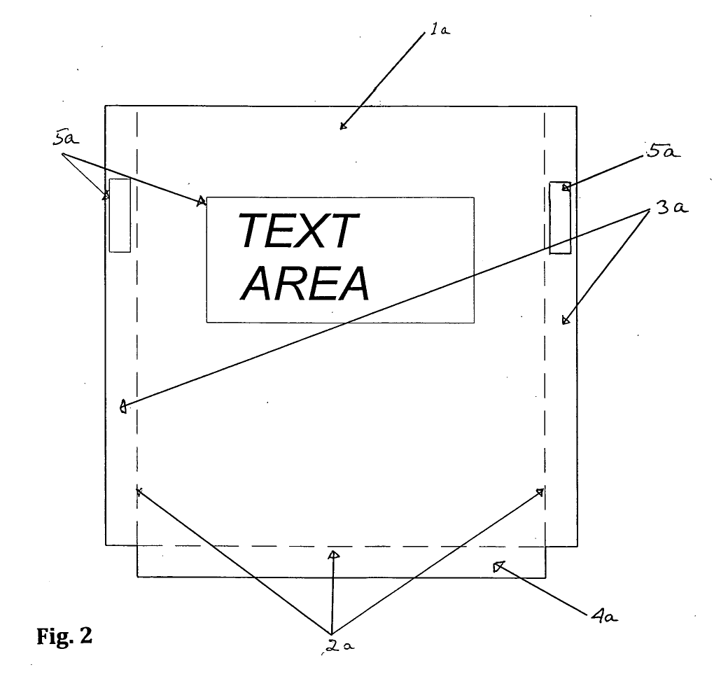

### DETAILED DESCRIPTION OF THE INVENTION

The present invention consists of a strong, safety barrier that can be affixed to the inside of a wood or metal-framed opening at a construction site so as to prevent passage and resulting injury while permitting installation of finished walls and flooring. In particular, the safety barrier consists of a material, in a substantially planar shape, that attaches to the lower, inside area between the rough opening of a passage way in the area of a building that is under construction and not safe for human passage, which when properly installed, will prevent human passage and resultant injury and also provide a written warning of danger, with an universally recognized symbol of danger from falling into a hazardous area. The barrier, when constructed of a rigid or semi-rigid material, has three flaps, one on each of the two lateral ends and one on the bottom, that are to be secured to the outside of the inner edge of the rough opening by inserting seven provided anchoring devices, which are accompanied by seven tight-fitting washers, through said flaps, at identified intervals, into said rough wood or metal-framed opening.

In the event that the rough opening is wood, the safety barrier is affixed to the opening by inserting seven provided, double-headed nails into provided seven tight-fitting washers, the nails thereafter being hammered through said flaps at intervals identified on said flaps into the lower portion of said wood-framed opening at the locations identified by printed marks, three on each side flap, and one in the center of the bottom flap. After the area surrounding the described barrier is rendered safe for human passage, said barrier is to be removed by using the nail removal part of a conventional hammer to remove the seven double-headed nails, using said hammer to grab the upper head of each nail and applying force opposite the head thereof, and by twisting the nail, while the hammer's head is supported by a one to two-inch thick block of wood, removal of said nails to include the accompanying washers; when said removal is complete, the safety barrier is to be discarded together with the devices used to secure it. Seven provided wood screws and snug-fitting washers also may be used to secure the safety barrier to a rough, wood stud opening.

In the event that the rough opening is metal, the safety barrier is affixed to the opening by inserting seven provided metal screws into seven snug-fitting washers (also provided), the screws thereafter being screwed through said side flaps into the lower portion of said metal-framed opening at the locations identified by printed marks, three on each side flap, and one in the center of the bottom flap. After construction in the area surrounding the described barrier is complete and rendered safe for human passage, said barrier is to be removed by unscrewing the screws used to affix the barrier to the metal-stud opening, and when said removal is complete, thereafter discarding said barrier together with the devices used to secure it.

We claim:

1. A strong, safety barrier that can be affixed to the inside of a wood-framed opening at a construction site so as to prevent passage and resulting injury while permitting installation of finished walls and flooring; in particular, the safety barrier consists of a material, in a substantially planar shape, that attaches to the lower, inside area between the rough opening of a passage way in the area of a building that is not safe for human passage, which when properly installed, will prevent human passage and resultant injury and also provide a written warning of danger on the non-hazardous side of the barrier, with a universally recognized symbol warning of danger; the barrier has three flaps, one on each of the two lateral ends of the substantially planar surface and one on the bottom, as indicated when the barrier is placed so that the signage is upright and readable, that are to be secured to the outside of the inner edge of the rough opening by inserting seven provided anchoring devices, which are accompanied by seven snug-fitting washers, through said flaps, into said rough opening at the locations identified;
the barrier has a written warning that describes the method of attachment to the rough opening, the danger of not so attaching the barrier, and instruction to discard the barrier after first use.

2. A strong, safety barrier, as described in claim 1, that is made of a light-weight, durable, polyethylene sheet material that is corrugated; the barrier has three flaps, indicated by an indentation in the polyethylene sheet, one on each of the two lateral ends of the substantially planar surface when the barrier is placed so that the signage is upright and readable, and one on the bottom, that are to be affixed from the non-hazardous side of such opening at the lower, outside edge of the inside of such opening in the manner indicated in claim 1.

3. A strong, safety barrier, as described in claim 1 above, except that the barrier consists of a polyethylene sheet material that is substantially solid and not corrugated, with three flaps indicated by a line of indentation and resultant flexibility.

4. A strong, safety barrier, as described in claim 1 above, except that the barrier consists of a strong, reinforced fabric that can be secured to the rough, wood opening by using the provided anchoring hardware to secure the fabric, which has anchoring grommets through which the anchoring hardware is to pass.

5. A strong, safety barrier, as described in claim 1 above, except that the dimensions of the substantially planar surface that comprises the barricade vary according to the size of the opening.

6. A strong, safety barrier, as described in claim 1 above, except that more than seven described attachment devices are used to anchor said barrier to the rough opening, including attachment to the floor of such opening.

7. A strong, safety barrier, as described in claim 1 above, except that the barrier bears a written warning of danger, on the non-hazardous side, which warning provides, “DANGER KEEP OUT”, with a universally recognized symbol warning of a danger of falling into a hazardous opening.

8. A strong, safety barrier, as described in claims 1, 2, 3, 4, 5 and 6 above, except that the barrier is attached to a rough, wood-framed opening by inserting seven provided, double-headed nails into provided seven tight-fitting washers, the nails thereafter being hammered through said flaps at intervals identified on said flaps into the wood frame of said opening at the locations identified by printed marks, and at the center of the bottom flap; after the area surrounding the described barrier is rendered safe for human passage, said barrier is to be removed by using the nail removal part of a conventional hammer to remove the seven double-headed nails, using said hammer to grab the upper head of each nail and applying force opposite the head thereof, and by twisting the nail, while the hammer's head is supported by a one to two-inch thick block of wood, removal of said nails to include the accompanying washers; when said removal is complete, thereafter discarding said barrier together with the nails and washers used to secure it.

9. A strong, safety barrier, as described in claim 8 above, except that the rough opening consists of wood studs, and the safety barrier is anchored to the wood frame at places indicated by using in each place a 1 ½″ wood screw and a provided snug-fitting washer.

10. A strong, safety barrier, as described in claim 1 above, except that the rough opening consists of a metal, stud frame, in which case the barrier is to be anchored to the rough metal stud opening at the places indicated by screwing the provided screws into said metal, stud frame through the side and bottom flaps of the barrier, at the locations indicated, into said metal, stud frame, using provided wood screws of appropriate length and provided snug-fitting washers.
